(19) United States
(12) Patent Application Publication
(10) Pub. No.: US 2026/0037818 A1
(43) Pub. Date: Feb. 5, 2026

(54) GENERATIVE ARTIFICIAL INTELLIGENCE GATING

(71) Applicant: Wells Fargo Bank, N.A., San Francisco, CA (US)

(72) Inventors: Rameshchandra Bhaskar Ketharaju, Hyderabad (IN); Anjeet Kumar, Bangalore (IN)

(21) Appl. No.: 18/788,937

(22) Filed: Jul. 30, 2024

(51) Int. Cl. G06N 3/091; G06N 3/0475; G06N 3/063

(52) U.S. Cl. CPC G06N 3/091; G06N 3/0475; G06N 3/063

(57) ABSTRACT

Systems and techniques to increase generative artificial intelligence accountability and explainability using information gates are described herein. A prompt directed to a generative artificial intelligence (AI) model is obtained and a group of input sets in a repository, and a set operation, are identified from the prompt. This set operation is applied to a first input set and a second input set to produce an inclusion filter. The inclusion filter specifies which data from the group of input sets is included in an intermediate set. The generative AI model is then invoked on this intermediate set to produce a result.

### TECHNICAL FIELD

Embodiments described herein generally relate to computer hardware platforms to run artificial intelligence models and more specifically to generative artificial intelligence gating.

### BACKGROUND

Artificial Intelligence (AI) encompasses technologies designed to perform tasks that typically require human intelligence. A subset of AI, generative AI, focuses on creating new content, such as text, images, or music, based on patterns learned from training data. Large Language Models (LLMs) are a specific type of generative AI trained on extensive text datasets to understand and generate human-like text. These models, such as GPT-4 and BERT, utilize deep learning techniques, particularly transformer architectures, to process language tasks, including text generation, translation, and summarization. Generative AI and LLMs rely on vast amounts of data and computational power to develop their capabilities, enabling applications in various domains such as content creation, automated customer service, and educational tools.

AI hardware platforms, commonly referred to as AI accelerators, are specialized computing devices designed to expedite machine learning and artificial intelligence tasks. These platforms include Tensor Processing Units (TPUs), Graphics Processing Units (GPUs), Field-Programmable Gate Arrays (FPGAs), and Application-Specific Integrated Circuits (ASICs). AI accelerators are optimized for the parallel processing requirements of AI workloads, offering improved performance and efficiency over general-purpose CPUs. They are utilized in various applications, including deep learning, natural language processing, and computer vision, enabling faster training and inference of complex models. The architecture of these platforms often includes high-bandwidth memory and specialized interconnects to manage large datasets and facilitate rapid data transfer.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for generative artificial intelligence gating, according to an embodiment.

FIG. 2 illustrates an example of a generative AI gate at input for an AI model, according to an embodiment.

FIG. 3 illustrates an example of using observer nodes to facilitate generative AI gating, according to an embodiment.

FIG. 4 illustrates a flow diagram of an example of a method for generative artificial intelligence gating, according to an embodiment.

FIG. 5 is a block diagram illustrating an example of a machine upon which one or more embodiments may be implemented.

### DETAILED DESCRIPTION

Determining how a generative AI, such as a Large Language Model (LLM), arrives at a given answer from a given input data set presents several issues. The complexity and opacity of these models, often described as the “black box” problem, make it difficult to trace specific outputs to individual inputs or internal parameters. The deep learning architectures used in LLMs, especially transformers, involve numerous layers and billions of parameters, contributing to this challenge. The non-deterministic (e.g., stochastic) nature of these models can also lead to different outputs for the same input under different conditions, complicating reproducibility and debugging. This opacity raises concerns about bias and accountability, as it is hard to account for (e.g., trace) the rationale behind the model's decisions or generated content. Efforts to improve model interpretability and explainability are ongoing. Techniques like model interpretability and explainability are being developed to address these issues, but they are still evolving and often provide limited insight.

Generative AI gating can address accountability issues inherent in generative AI systems. Generative AI gating integrates gating devices into platforms, such as AI hardware accelerators, either at the point of data ingestion or between layers of neurons within an AI model. The gating devices perform data collection and filtration before the data is used as input to an AI inference model. Thus, the gating devices address various issues, including bias and accuracy, that threaten reliable operation of AI systems.

In an example, the gating devices can report on data used by the model. This reporting enables future modifications to gate parameters to improve future performance. For example, observer nodes can be employed to collect signals that pass between neurons while the AI platform is in operation. This allows for a detailed analysis of the impact that input data has at different stages within the AI model. Over time, a continuous adjustment process based on observed data flows through the model can lead to significant improvements in AI model accuracy, elimination of bias, or explainability.

In an example, In addition to monitoring, observer nodes can also act as gating devices. They can interrupt or block signals between neurons to observe the subsequent impact on AI model output. This enables a detailed examination of the contribution of individual neurons to the overall output of the AI model. By understanding these contributions, it becomes possible to fine-tune the model for better performance.

The integration of gating devices and observer nodes within AI platforms is a significant step towards enhancing the accountability, accuracy, and explainability of generative AI systems. The monitoring and reporting capabilities provided by these devices enable ongoing improvements and refinements, ensuring that the AI model remains reliable and effective. Further details and examples are provided below.

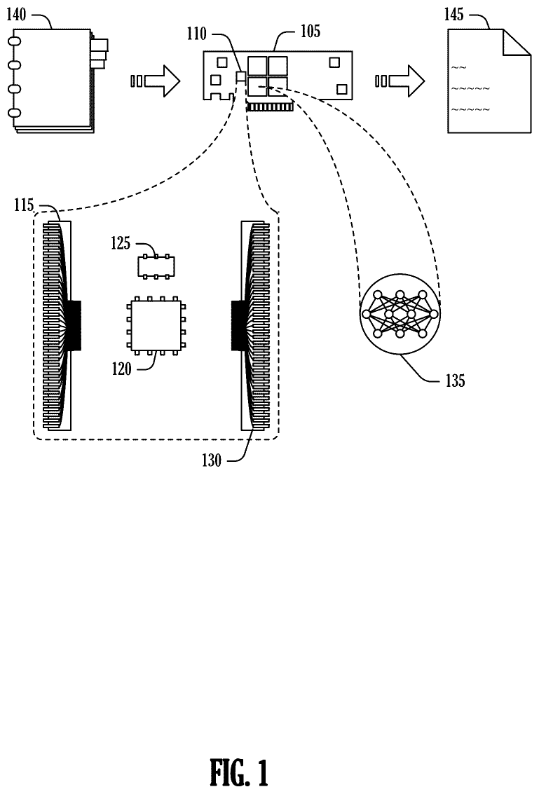

FIG. 1 is a block diagram of an example of an environment including a system 105 for generative AI gating, according to an embodiment. The system 105 includes a neuronal gate 110. The neuronal gate 110 includes processing circuitry 120, a memory 125, an input interface 115, and an output interface 130. In an example, the input interface 115 and the output interface 130 are the same interface, such as a bi-directional input-output (IO) interface.

In an example, the processing circuitry 120 is an FPGA that is configured via instructions stored in the memory 125. When in operation, the input interface 115 is configured to obtain (e.g., retrieve or receive) data from a repository 140. When in operation, the output interface 130 is configured to provide the output of the processing circuitry 120 to the generative AI model 135 operating on the system 105. The generative AI model 135 can be operating on other processors of the system 105, such as single-instruction-multiple-data (SIMD) cores that are often used in AI accelerator hardware. However, in an example, the AI model can be implemented on neuromorphic hardware or other processor configurations as well. For simplicity, the following examples use the processing circuitry 120 as the operating element. However, other elements of the system 105 can be used to perform the techniques described below. The output 145 of the system 105 can be an inference from the generative AI model 135 or another version of the generative AI model 135, as can occur during training.

The processing circuitry 120 is configured to obtain a prompt directed to the generative AI model 135 is obtained. Generally, in generative AI applications, a prompt serves as the initial input for a generative AI model 135, specifying the context and content that the model is to generate. The prompt can include the initial data or instructions to the generative AI model 135 and influences the output 145. The prompt usually sets the context for the generation process by including specific instructions, questions, or statements that direct the generative AI model 135 towards producing relevant results. By varying the prompt, users (e.g., live users, application, etc.) can influence the output 145 to achieve more accurate or relevant results. In this context, the processing circuitry 120 obtains the prompt before the prompt is ingested (e.g., used as input to) the generative AI model 135.

The processing circuitry 120 is configured to identify a group of input sets in a repository 140 from the prompt. Here, each input set in the group of input sets includes data that may be provided as input to the generative artificial intelligence model. Input set identification can be accomplished in a number of ways. For example, an embedding for the prompt can be created. The data sets in the repository 140 can already have embeddings, or embeddings can be performed after the prompt is performed. Then, the processing circuitry 120 can perform a similarity analysis (e.g., Euclidean distance, cosine similarity, dot product similarity, etc.) on the vector space of the embeddings to identify one or more data sets that are within a threshold similarity, or simply the top threshold (e.g., top ten) closest to the prompt. Other techniques can include key-word tagging, branching, etc. used to identify data sets that match, or are close (e.g., within a threshold count or similarity metric) to the prompt.

The processing circuitry 120 is configured to obtain the group of inputs sets from the repository 140. For example, the processing circuitry 120 can execute a query of a data base housing the repository 140, or cause the query to be execute, to retrieve the data of the data sets. Other examples can include retrieving the data from a buffer, memory, or other storage of the system 105 using the input interface 115.

The processing circuitry 120 is configured to identify a set operation that applies to a first input set and a second input set from the prompt. Here, the first input set and the second input set are in the group of input sets. A variety of set operations can be identified based on the prompt. For example, if the prompt is “what houses for sale in my state do not have two bathrooms?” the inputs sets could be houses for sale, houses in my state, and houses with two bathrooms. Here, the set operations can include an intersection operation between houses for sale with a difference operation with houses with two bathrooms. Thus, in an example, the set operation is intersection.

The processing circuitry 120 is configured to apply the set operation to the first input set and the second input set to produce an inclusion filter. Here, the inclusion filter determines which of the elements of the first input set and the second input set will pass the filter. In an example, where the set operation is intersection, applying the set operation to the first input set and the second input set includes performing an intersection on the first input set and the second input set. In this example, then, the intersection of the two sets are those elements that pass the inclusion filter. In an example, where the set operation is intersection, applying the set operation to the first input set and the second input set includes applying an intersection on a third input set in the group of input sets and the first input set or the second input set. A variety of different types of set operations can be performed in this manner. For example, sets A and B may be UNIONed a then intersected with another set C. If set A is apartments, and set B is houses, and set C is a geographic area, such an arrangement could arise from a prompt such as “what housing is available in my city.”

The processing circuitry 120 is configured to apply the inclusion filter to the group of input sets to produce an intermediate set. This inclusion filter specifies which data from the group of input sets is included in the intermediate set. The intermediate set is so named because it is intermediate between the input data sets and the generative AI model 135. There are circumstances in which additional manipulations to the intermediate set, before being used for training or inference, can be helpful. In an example, the processing circuitry 120 obtains a negation set and applies the negation set to the intermediate set to remove data from the intermediate set that specified in the negation set prior to invoking the generative AI model 135 on the intermediate set. The negation set operates as an “exclusion list,” or something similar, to enable specific data to be excluded from training or inference. This can address issues of inappropriate or sensitive data being included in the generative AI model 135 (e.g., from training) or being outputted from the generative AI model 135 (e.g., from inference).

In an example, the processing circuitry 120 can include one or more FPGA devices to perform tasks. In an example, the identification from the prompt the group of input sets in the repository is performed by an FPGA. In an example, the obtainment of the group of input sets from the repository is performed by an FPGA. In an example, identification of the set operation from the prompt that applies to the first input set and the second input set is performed by an FPGA. In an example, application of the set operation to the first input set to produce the inclusion filter is performed by an FPGA. In an example, application of the inclusion filter to the group of input sets is performed by an FPGA.

The processing circuitry 120 is configured to invoke (e.g., execute, run, etc.) the generative AI model 135 on the intermediate set to produce a result. Here the invocation of the generative AI model 135 can include training or inference. Generally, training implies changes to the structure of the generative AI model (e.g., modifying inter-neuronal weights, sensitivity, etc.) while inference does not involve such changes. Inference is generally used to produce an “answer” while the output 145 of the generative AI model 135 during training is used to correct the model structure (e.g., using back-propagation or the like).

Observer nodes are elements that operate to observe or gate (e.g., block or modify signals) in between neurons of the generative AI model 135. Thus, in an example, the processing circuitry 120 is configured to dispose an observer node between a first hidden layer and a second hidden layer of the generative AI model 135.

In this example, the observer node is configured to record an activation signal between a first node of the first hidden layer and a second node of the second hidden layer during inference or training. Activation signal (e.g., post weight firing value, etc.) represents the stimulus that the first node is applying to the second node. Such monitoring can give insight into what neuron pathways comprise a given result for a given intermediate set. These observations can be separately reported or chained to provide an aggregated report at the conclusion of a given invocation of the generative AI model 135. Accordingly, in an example, the observer node is configured to forward the activation signal to a second observer node that is disposed between the second hidden layer and a third hidden layer. In an example, the activation signal is forwarded during feedforward operations of activation signals in the generative AI model 135. Thus, the observer nodes chain the observed signals and forward the results along with the results of data passing through the generative AI model 135.

In an example, the processing circuitry 120 is configured to capture activation signals from observer nodes after an inference and configured to determine a mismatch between a result of the inference and an expected result. In an example, identification of the group of input sets or the set operation based on the prompt can be modified based on the mismatch. These examples tie the failure of a result (e.g., the inclusion of biased or false information) to the input data sets. Thus, the inclusion filter, negation set, or even input set selection can be modified to help to prevent this situation from arising in the future.

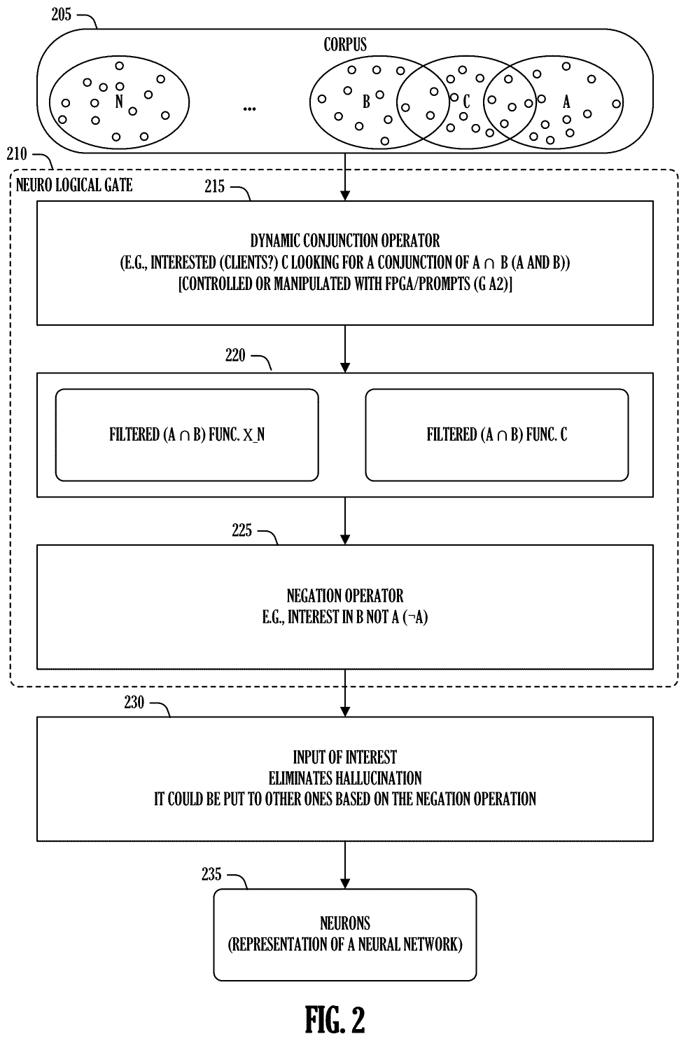

FIG. 2 illustrates an example of a generative AI gate 210 at input for an AI model 235, according to an embodiment. The generative AI gate 210 can be part of a platform in which different AI models can be quickly imported and run with common input and output interfaces. This can enable different AI models to be swapped into a pipeline without redesigning other pipeline elements. In an example, the platform can operate as a “sandbox” for the different AI models.

As illustrated, the generative AI gate 210 includes conjoiner circuitry 215, filter circuitry 220, and negation circuitry 225. In broad strokes, the conjoiner circuitry is configured to identify corpuses, the filter circuitry 220 selects data identified by the conjoiner circuitry 215 (e.g., filters some of that data out), and the negation circuitry 225 removes specific items from the data that passes the filter circuitry 220. The final result after passing through these stages is the input of interest 230, which is provided as input data to the AI model 235.

As noted above, in general, generative AI models begin with a prompt. Before the prompt is presented to the AI model 235, it is obtained (e.g., captured) by the generative AI gate 210. Assuming the repository 205 of available corpuses, the conjoiner circuitry 215 identifies a set of corpuses from the repository 205 and a set operation to perform on the set of corpuses from the prompt. For example, if the prompt is “identify employees of XYZ with a dog or a cat,” and the repository had a corpus of employees of ABC, a corpus of employees of XYZ, a corpus of dog owners, a corpus of cat owners, and a corpus of snake owners, the conjoiner circuitry 215 identifies the corpuses and set operations as:
(employees XZY∩dog owners)∪(employees XZY∩cat owners)

This conjunction captures the relevant employees without over including irrelevant data, such as dog owners that are not employees, or employees of ABC that own snakes. Limiting the input data helps to ensure that irrelevant data doesn't, for example, skew AI model training or introduce edge cases that the AI model 235 is not properly trained, leading to better outputs.

Once the data in the repository data is limited by the conjoiner circuitry 215, a filter can be applied by the filter circuitry. The filter can be one or several functions that are applied. An example of such a function can include limiting data to a particular time-frame, ensuring a minimum number of elements in the data (e.g., to ensure a statistical representation), or identification of patterns previously linked to poor inference or training performance. The function can be created via feedback mechanisms (e.g., using observer nodes), or loaded from configuration files and the like. In an example, the filter is another group of data upon which a set operation is performed with the output from the conjoiner circuitry 215. In this example, then, the filter operates like another corpus being combined under a set operation. Thus, the specific filter can be identified from the prompt, or can be hardcoded (e.g., to eliminate bias) in data.

While the sophistication and power of the conjoiner circuitry 215 and the filter circuitry 220 can address many different scenarios, there are some elements that can be readily identified and eliminated. The negation circuitry 225 is configured to enable this functionality by identifying elements of the data that are restricted and eliminating them. This application of an elimination list enables a fast and straightforward technique to eliminate company secrets (e.g., project code names), protected data (e.g., personally identifiable information), and bias (e.g., racial epithets, stereotypes, etc.).

These elements together operates to ensure that the data used to train the AI model does not include elements that would lead to improper outputs during inferencing. Similarly, during inferencing, the restriction of input data helps to ensure results that are acceptable and accurate (e.g., by limiting data from which hallucinations can arise).

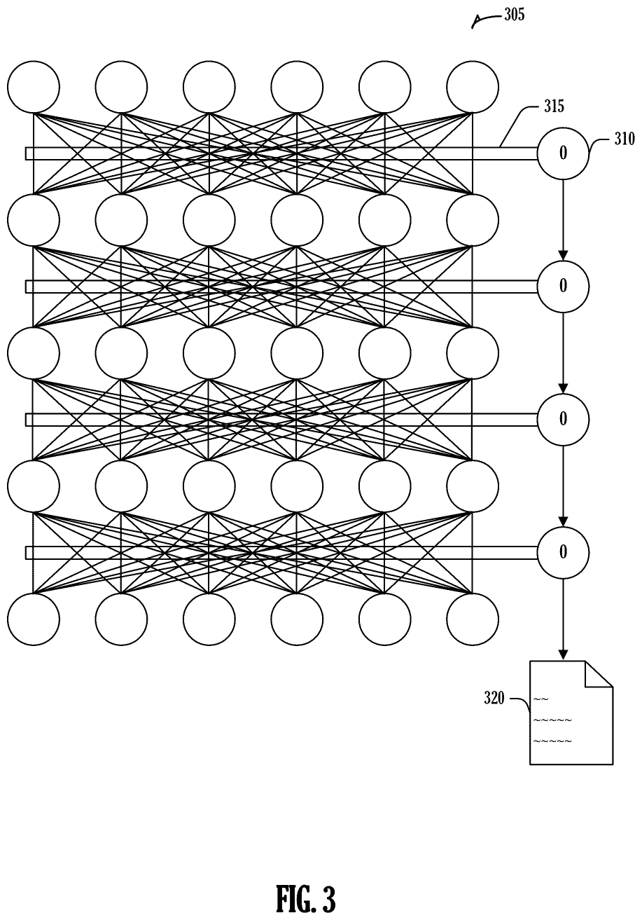

FIG. 3 illustrates an example of using observer nodes to facilitate generative AI gating, according to an embodiment. In contrast to the generative AI gate 210 illustrated in FIG. 2, the observer nodes operate within the AI model rather than on manipulating the input data to the AI model 235. As illustrated, an AI model 305 has observer nodes placed to read signals (e.g., weights, neuronal firings, etc.) between layers of the AI model 305. Thus, the observer node 310 has an interface 315 to gather the signals between neurons in the first layer and the second layer of the AI model 305. The observer nodes are also illustrated with a feed-forward connection to a next observer node. This can be used to aggregate signals during operation of the AI model 305 and produce a report 320. The report 320 thus enables a correlation between inter-layer neuronal signaling and an output by the AI model 305. This arrangement enables backtracking from the output to the input to identify new input filtering, such as that illustrated in FIG. 2. This can increase the explainability of any given inference output made by the AI model 305 for a given input.

In an example, the observer nodes are configured to also operate as a gate, rather than just an observer. As a gate, the observer node 310 can prevent a signal from propagating or can modify the signal. In this way, patterns of signaling that have previously been identified with undesirable inference behavior can be intercepted and modified while the AI model 305 is running.

In an example, the observer node 310 is configured to perform sequential layer activation. Here, the observer node 310 can interrupt a given signal (e.g., connection between two neurons) in order to observe the change in AI model output. By methodically interrupting signals, a better understanding of which signals (e.g., connections) between neurons are important (e.g., lead to measurable changes in output) or are not important (e.g., lead to changes below a threshold in the output). The sequential activation and deactivation of layers within the AI model 305 enables quantification of the individual neuron, or neuron layer, contributions to the output. By selectively switching off layers and observing the changes in output, identification of the layers most responsible for any biases or errors in the final output can be made.

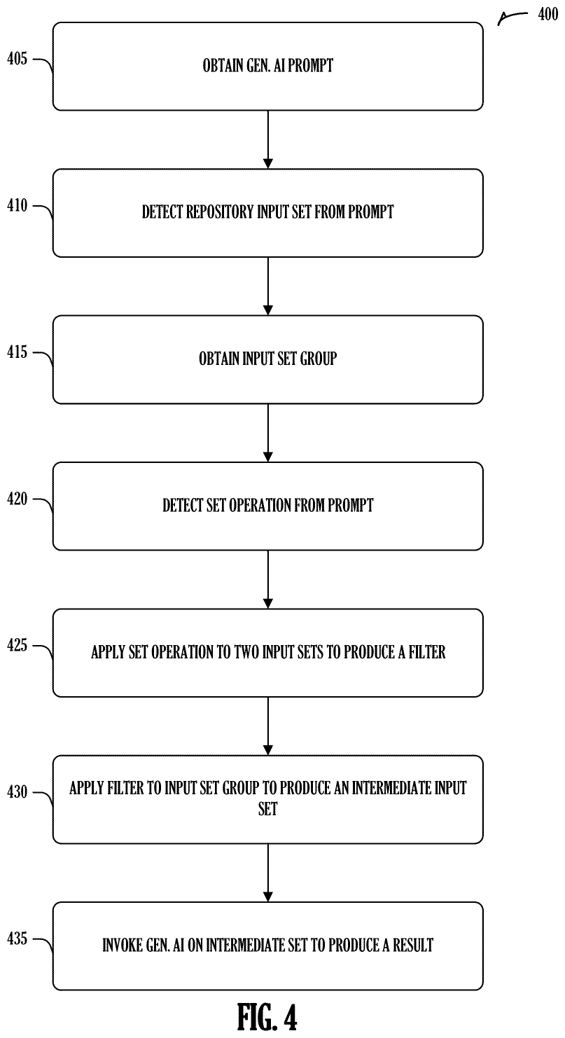

FIG. 4 illustrates a flow diagram of an example of a method 400 for generative artificial intelligence gating, according to an embodiment. The operations of the method 400 are performed by computer hardware, such as that described above or below (e.g., processing circuitry).

At operation 405, a prompt directed to a generative AI model is obtained.

At operation 410, a group of input sets in a repository is identified from the prompt. Here, each input set in the group of input sets includes data that may be provided as input to the generative artificial intelligence model.

At operation 415, the group of input sets is obtained from the repository.

At operation 420, a set operation that applies to a first input set and a second input set is identified from the prompt. Here, the first input set and the second input set are in the group of input sets. In an example, the set operation is intersection.

At operation 425, the set operation is applied to the first input set and the second input set to produce an inclusion filter. In an example, where the set operation is intersection, applying the set operation to the first input set and the second input set includes performing an intersection on the first input set and the second input set. In an example, where the set operation is intersection, applying the set operation to the first input set and the second input set includes applying an intersection on a third input set in the group of input sets and the first input set or the second input set.

At operation 430, the inclusion filter is applied to the group of input sets to produce an intermediate set. This inclusion filter specifies which data from the group of input sets is included in the intermediate set.

In an example, a negation set is obtained. The negation set can be applied to the intermediate set to remove data from the intermediate set that specified in the negation set prior to invoking the generative AI model on the intermediate set (operation 435).

At operation 435, the generative AI model is invoked on the intermediate set to produce a result.

In an example, a field programmable gate array (FPGA) is used to perform the operations of identifying from the prompt the group of input sets in the repository (operation 410), obtaining the group of input sets from the repository (operation 415), identifying a set operation from the prompt that applies to the first input set and the second input set (operation 420), applying the set operation to the first input set to produce the inclusion filter (operation 425), or applying the inclusion filter to the group of input sets (operation 430).

In an example, the operation of the method 400 can include disposing between a first hidden layer and a second hidden layer of the generative artificial intelligence model an observer node. In this example, the observer node is configured to record an activation signal between a first node of the first hidden layer and a second node of the second hidden layer during inference or training. In an example, the observer node is configured to forward the activation signal to a second observer node that is disposed between the second hidden layer and a third hidden layer. In an example, the activation signal is forwarded during feedforward operations of activation signals in the generative AI model. In an example, the operations of the method 400 also include capturing activation signals from observer nodes after an inference and determining a mismatch between a result of the inference and an expected result. In an example, identification of the group of input sets or the set operation based on the prompt can be modified based on the mismatch.

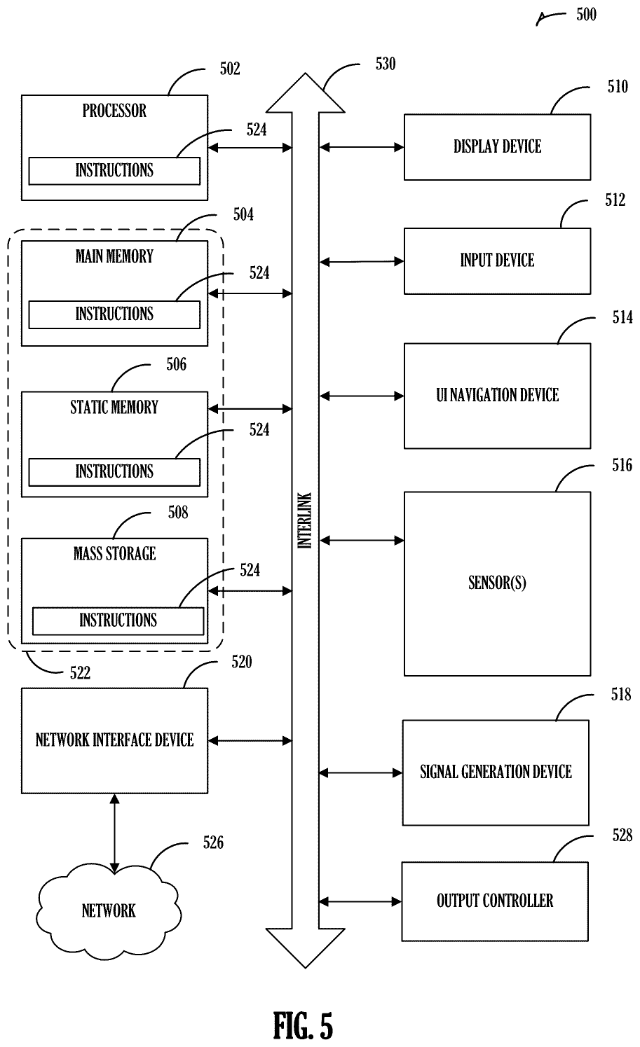

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is a device for generative artificial intelligence gating, the device comprising: an interface configured to obtain a prompt directed to a generative artificial intelligence model; and processing circuitry configured to: identify from the prompt a group of input sets in a repository, each input set in the group of input sets including data that may be provided as input to the generative artificial intelligence model; obtain the group of input sets from the repository; identify, from the prompt, a set operation that applies to a first input set and a second input set, the first input set and the second input set being in the group of input sets; apply the set operation to the first input set and the second input set to produce an inclusion filter; apply the inclusion filter to the group of input sets to produce an intermediate set, the inclusion filter specifying which data from the group of input sets is included in the intermediate set; and invoke the generative artificial intelligence model on the intermediate set to produce a result.

In Example 2, the subject matter of Example 1, comprising a second interface configured to obtain a negation set, wherein the processing circuitry is configured to apply the negation set to the intermediate set to remove data from the intermediate set that is specified in the negation set prior to invoking the generative artificial intelligence model on the intermediate set.

In Example 3, the subject matter of any of Examples 1-2, wherein the set operation is intersection.

In Example 4, the subject matter of Example 3, wherein, to apply the set operation to the first input set and the second input set, the processing circuitry is configured to perform an intersection on the first input set and the second input set.

In Example 5, the subject matter of any of Examples 3-4, wherein, to apply the set operation to the first input set and the second input set, the processing circuitry is configured to apply an intersection on a third input set in the group of input sets and the first input set or the second input set.

In Example 6, the subject matter of any of Examples 1-5, wherein the processing circuitry includes a field programmable gate array (FPGA), and wherein the FPGA is configured to: identify from the prompt the group of input sets in the repository; obtain the group of input sets from the repository; identify a set operation from the prompt that applies to the first input set and the second input set; apply the set operation to the first input set to produce the inclusion filter; or apply the inclusion filter to the group of input sets.

In Example 7, the subject matter of any of Examples 1-6, wherein the processing circuitry is configured to dispose an observer node between a first hidden layer and a second hidden layer of the generative artificial intelligence model, the observer node configured to record an activation signal between a first node of the first hidden layer and a second node of the second hidden layer during inference or training.

In Example 8, the subject matter of Example 7, wherein the observer node is configured to forward the activation signal to a second observer node that is disposed between the second hidden layer and a third hidden layer.

In Example 9, the subject matter of Example 8, wherein the activation signal is forwarded during feedforward operations of activation signals in the generative artificial intelligence model.

In Example 10, the subject matter of any of Examples 8-9, wherein the processing circuitry is configured to: capture activation signals from observer nodes after an inference; determine a mismatch between a result of the inference and an expected result; and modify identification of the group of input sets or the set operation based on the prompt based on the mismatch.

In Example 11, the subject matter of any of Examples 1-10, wherein the device is configured to be a component in an AI system-on-chip.

Example 12 is a method for generative artificial intelligence gating, the method comprising: obtaining a prompt directed to a generative artificial intelligence model; identifying from the prompt a group of input sets in a repository, each input set in the group of input sets including data that may be provided as input to the generative artificial intelligence model; obtaining the group of input sets from the repository; identifying, from the prompt, a set operation that applies to a first input set and a second input set, the first input set and the second input set being in the group of input sets; applying the set operation to the first input set and the second input set to produce an inclusion filter; applying the inclusion filter to the group of input sets to produce an intermediate set, the inclusion filter specifying which data from the group of input sets is included in the intermediate set; and invoking the generative artificial intelligence model on the intermediate set to produce a result.

In Example 13, the subject matter of Example 12, comprising: obtaining a negation set; and applying the negation set to the intermediate set to remove data from the intermediate set that is specified in the negation set prior to invoking the generative artificial intelligence model on the intermediate set.

In Example 14, the subject matter of any of Examples 12-13, wherein the set operation is intersection.

In Example 15, the subject matter of Example 14, wherein applying the set operation to the first input set and the second input set includes performing an intersection on the first input set and the second input set.

In Example 16, the subject matter of any of Examples 14-15, wherein applying the set operation to the first input set and the second input set includes applying an intersection on a third input set in the group of input sets and the first input set or the second input set.

In Example 17, the subject matter of any of Examples 12-16, wherein a field programmable gate array (FPGA) is used to perform: identifying from the prompt the group of input sets in the repository; obtaining the group of input sets from the repository; identifying a set operation from the prompt that applies to the first input set and the second input set; applying the set operation to the first input set to produce the inclusion filter; or applying the inclusion filter to the group of input sets.

In Example 18, the subject matter of any of Examples 12-17, comprising disposing between a first hidden layer and a second hidden layer of the generative artificial intelligence model an observer node, the observer node configured to record an activation signal between a first node of the first hidden layer and a second node of the second hidden layer during inference or training.

In Example 19, the subject matter of Example 18, wherein the observer node is configured to forward the activation signal to a second observer node that is disposed between the second hidden layer and a third hidden layer.

In Example 20, the subject matter of Example 19, wherein the activation signal is forwarded during feedforward operations of activation signals in the generative artificial intelligence model.

In Example 21, the subject matter of any of Examples 19-20, comprising: capturing activation signals from observer nodes after an inference; determining a mismatch between a result of the inference and an expected result; and modifying identification of the group of input sets or the set operation based on the prompt based on the mismatch.

Example 22 is a machine readable medium including instructions for generative artificial intelligence gating, the instructions, when executed by processing circuitry, cause the processing circuitry to perform operations comprising: obtaining a prompt directed to a generative artificial intelligence model; identifying from the prompt a group of input sets in a repository, each input set in the group of input sets including data that may be provided as input to the generative artificial intelligence model; obtaining the group of input sets from the repository; identifying, from the prompt, a set operation that applies to a first input set and a second input set, the first input set and the second input set being in the group of input sets; applying the set operation to the first input set and the second input set to produce an inclusion filter; applying the inclusion filter to the group of input sets to produce an intermediate set, the inclusion filter specifying which data from the group of input sets is included in the intermediate set; and invoking the generative artificial intelligence model on the intermediate set to produce a result.

In Example 23, the subject matter of Example 22, wherein the operations comprise: obtaining a negation set; and applying the negation set to the intermediate set to remove data from the intermediate set that is specified in the negation set prior to invoking the generative artificial intelligence model on the intermediate set.

In Example 24, the subject matter of any of Examples 22-23, wherein the set operation is intersection.

In Example 25, the subject matter of Example 24, wherein applying the set operation to the first input set and the second input set includes performing an intersection on the first input set and the second input set.

In Example 26, the subject matter of any of Examples 24-25, wherein applying the set operation to the first input set and the second input set includes applying an intersection on a third input set in the group of input sets and the first input set or the second input set.

In Example 27, the subject matter of any of Examples 22-26, wherein the processing circuitry includes a field programmable gate array (FPGA) that is used to perform: identifying from the prompt the group of input sets in the repository; obtaining the group of input sets from the repository; identifying a set operation from the prompt that applies to the first input set and the second input set; applying the set operation to the first input set to produce the inclusion filter; or applying the inclusion filter to the group of input sets.

In Example 28, the subject matter of any of Examples 22-27, wherein the operations comprise disposing between a first hidden layer and a second hidden layer of the generative artificial intelligence model an observer node, the observer node configured to record an activation signal between a first node of the first hidden layer and a second node of the second hidden layer during inference or training.

In Example 29, the subject matter of Example 28, wherein the observer node is configured to forward the activation signal to a second observer node that is disposed between the second hidden layer and a third hidden layer.

In Example 30, the subject matter of Example 29, wherein the activation signal is forwarded during feedforward operations of activation signals in the generative artificial intelligence model.

In Example 31, the subject matter of any of Examples 29-30, wherein the operations comprise: capturing activation signals from observer nodes after an inference; determining a mismatch between a result of the inference and an expected result; and modifying identification of the group of input sets or the set operation based on the prompt based on the mismatch.

Example 32 is a system for generative artificial intelligence gating, the system comprising: means for obtaining a prompt directed to a generative artificial intelligence model; means for identifying from the prompt a group of input sets in a repository, each input set in the group of input sets including data that may be provided as input to the generative artificial intelligence model; means for obtaining the group of input sets from the repository; means for identifying, from the prompt, a set operation that applies to a first input set and a second input set, the first input set and the second input set being in the group of input sets; means for applying the set operation to the first input set and the second input set to produce an inclusion filter; means for applying the inclusion filter to the group of input sets to produce an intermediate set, the inclusion filter specifying which data from the group of input sets is included in the intermediate set; and means for invoking the generative artificial intelligence model on the intermediate set to produce a result.

In Example 33, the subject matter of Example 32, comprising: means for obtaining a negation set; and means for applying the negation set to the intermediate set to remove data from the intermediate set that is specified in the negation set prior to invoking the generative artificial intelligence model on the intermediate set.

In Example 34, the subject matter of any of Examples 32-33, wherein the set operation is intersection.

In Example 35, the subject matter of Example 34, wherein the means for applying the set operation to the first input set and the second input set include means for performing an intersection on the first input set and the second input set.

In Example 36, the subject matter of any of Examples 34-35, wherein the means for applying the set operation to the first input set and the second input set include means for applying an intersection on a third input set in the group of input sets and the first input set or the second input set.

In Example 37, the subject matter of any of Examples 32-36, wherein the system includes a field programmable gate array (FPGA), and wherein the FPGA is used to implement: the means for identifying from the prompt the group of input sets in the repository; the means for obtaining the group of input sets from the repository; the means for identifying a set operation from the prompt that applies to the first input set and the second input set; the means for applying the set operation to the first input set to produce the inclusion filter; or the means for applying the inclusion filter to the group of input sets.

In Example 38, the subject matter of any of Examples 32-37, comprising the means for disposing between a first hidden layer and a second hidden layer of the generative artificial intelligence model an observer node, the observer node configured to record an activation signal between a first node of the first hidden layer and a second node of the second hidden layer during inference or training.

In Example 39, the subject matter of Example 38, wherein the observer node is configured to forward the activation signal to a second observer node that is disposed between the second hidden layer and a third hidden layer.

In Example 40, the subject matter of Example 39, wherein the activation signal is forwarded during feedforward operations of activation signals in the generative artificial intelligence model.

In Example 41, the subject matter of any of Examples 39-40, comprising: the means for capturing activation signals from observer nodes after an inference; the means for determining a mismatch between a result of the inference and an expected result; and the means for modifying identification of the group of input sets or the set operation based on the prompt based on the mismatch.

Example 42 is at least one machine-readable medium including instructions that, when executed by processing circuitry, cause the processing circuitry to perform operations to implement of any of Examples 1-41.

Example 43 is an apparatus comprising means to implement of any of Examples 1-41.

Example 44 is a system to implement of any of Examples 1-41.

Example 45 is a method to implement of any of Examples 1-41.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for generative artificial intelligence gating, the device comprising:
an interface configured to obtain a prompt directed to a generative artificial intelligence model; and
processing circuitry configured to:
identify from the prompt a group of input sets in a repository, each input set in the group of input sets including data that may be provided as input to the generative artificial intelligence model;
obtain the group of input sets from the repository;
identify, from the prompt, a set operation that applies to a first input set and a second input set, the first input set and the second input set being in the group of input sets;
apply the set operation to the first input set and the second input set to produce an inclusion filter;
apply the inclusion filter to the group of input sets to produce an intermediate set, the inclusion filter specifying which data from the group of input sets is included in the intermediate set; and
invoke the generative artificial intelligence model on the intermediate set to produce a result.

2. The device of claim 1, comprising a second interface configured to obtain a negation set, wherein the processing circuitry is configured to apply the negation set to the intermediate set to remove data from the intermediate set that is specified in the negation set prior to invoking the generative artificial intelligence model on the intermediate set.

3. The device of claim 1, wherein the set operation is intersection.

4. The device of claim 3, wherein, to apply the set operation to the first input set and the second input set, the processing circuitry is configured to perform an intersection on the first input set and the second input set.

5. The device of claim 3, wherein, to apply the set operation to the first input set and the second input set, the processing circuitry is configured to apply an intersection on a third input set in the group of input sets and the first input set or the second input set.

6. The device of claim 1, wherein the processing circuitry includes a field programmable gate array (FPGA), and wherein the FPGA is configured to:
identify from the prompt the group of input sets in the repository;
obtain the group of input sets from the repository;
identify a set operation from the prompt that applies to the first input set and the second input set;
apply the set operation to the first input set to produce the inclusion filter; or
apply the inclusion filter to the group of input sets.

7. The device of claim 1, wherein the processing circuitry is configured to dispose an observer node between a first hidden layer and a second hidden layer of the generative artificial intelligence model, the observer node configured to record an activation signal between a first node of the first hidden layer and a second node of the second hidden layer during inference or training.

8. The device of claim 7, wherein the observer node is configured to forward the activation signal to a second observer node that is disposed between the second hidden layer and a third hidden layer.

9. The device of claim 8, wherein the activation signal is forwarded during feedforward operations of activation signals in the generative artificial intelligence model.

10. The device of claim 8, wherein the processing circuitry is configured to:
capture activation signals from observer nodes after an inference;
determine a mismatch between a result of the inference and an expected result; and
modify identification of the group of input sets or the set operation based on the prompt based on the mismatch.

11. The device of claim 1, wherein the device is configured to be a component in an AI system-on-chip.

12. A method for generative artificial intelligence gating, the method comprising:
obtaining a prompt directed to a generative artificial intelligence model;
identifying from the prompt a group of input sets in a repository, each input set in the group of input sets including data that may be provided as input to the generative artificial intelligence model;
obtaining the group of input sets from the repository;
identifying, from the prompt, a set operation that applies to a first input set and a second input set, the first input set and the second input set being in the group of input sets;
applying the set operation to the first input set and the second input set to produce an inclusion filter;
applying the inclusion filter to the group of input sets to produce an intermediate set, the inclusion filter specifying which data from the group of input sets is included in the intermediate set; and
invoking the generative artificial intelligence model on the intermediate set to produce a result.

13. The method of claim 12, comprising:
obtaining a negation set; and
applying the negation set to the intermediate set to remove data from the intermediate set that is specified in the negation set prior to invoking the generative artificial intelligence model on the intermediate set.

14. The method of claim 12, wherein a field programmable gate array (FPGA) is used to perform:
identifying from the prompt the group of input sets in the repository;
obtaining the group of input sets from the repository;
identifying a set operation from the prompt that applies to the first input set and the second input set;
applying the set operation to the first input set to produce the inclusion filter; or
applying the inclusion filter to the group of input sets.

15. The method of claim 12, comprising disposing between a first hidden layer and a second hidden layer of the generative artificial intelligence model an observer node, the observer node configured to record an activation signal between a first node of the first hidden layer and a second node of the second hidden layer during inference or training.

16. A machine readable medium including instructions for generative artificial intelligence gating, the instructions, when executed by processing circuitry, cause the processing circuitry to perform operations comprising:
obtaining a prompt directed to a generative artificial intelligence model;
identifying from the prompt a group of input sets in a repository, each input set in the group of input sets including data that may be provided as input to the generative artificial intelligence model;
obtaining the group of input sets from the repository;
identifying, from the prompt, a set operation that applies to a first input set and a second input set, the first input set and the second input set being in the group of input sets;
applying the set operation to the first input set and the second input set to produce an inclusion filter;
applying the inclusion filter to the group of input sets to produce an intermediate set, the inclusion filter specifying which data from the group of input sets is included in the intermediate set; and
invoking the generative artificial intelligence model on the intermediate set to produce a result.

17. The machine readable medium of claim 16, wherein the operations comprise:
obtaining a negation set; and
applying the negation set to the intermediate set to remove data from the intermediate set that is specified in the negation set prior to invoking the generative artificial intelligence model on the intermediate set.

18. The machine readable medium of claim 16, wherein the processing circuitry includes a field programmable gate array (FPGA) that is used to perform:
identifying from the prompt the group of input sets in the repository;
obtaining the group of input sets from the repository;
identifying a set operation from the prompt that applies to the first input set and the second input set;
applying the set operation to the first input set to produce the inclusion filter; or
applying the inclusion filter to the group of input sets.

19. The machine readable medium of claim 16, wherein the operations comprise disposing between a first hidden layer and a second hidden layer of the generative artificial intelligence model an observer node, the observer node configured to record an activation signal between a first node of the first hidden layer and a second node of the second hidden layer during inference or training.

20. The machine readable medium of claim 19, wherein the observer node is configured to forward the activation signal to a second observer node that is disposed between the second hidden layer and a third hidden layer.
